(19) United States
(12) Patent Application Publication
(10) Pub. No.: US 2005/0236868 A1
(43) Pub. Date: Oct. 27, 2005

(54) Glass latch tensile load disbursement assembly

(75) Inventors: Curtis D. Beekman, Burlington, IA (US); Philip A. Iannarelli, Burlington, IA (US); Richard D. Housman, Mediapolis, IA (US); John Kinney, Burlington, IA (US)

Correspondence Address: STEPHEN M. PATTON, 7881 GROVE COURT EAST, GERMANTOWN, TN, 38138, US

(73) Assignee: CNH America LLC,

(21) Appl. No.: 10/832,897

(22) Filed: Apr. 27, 2004

(51) Int. Cl. B60J 7/00

(52) U.S. Cl. 296/190.1

(57) ABSTRACT

A window support assembly is provided having a first plate, a window panel with first and second sides and a high modulus of elasticity cured resin first layer bonded to and disposed between the first plate and the first surface of the window panel. The assembly may include a latch fixed to the plate or a second plate fixed to the other surface of the glass. A fastener or fasteners may compress the first and second plates together.

### RELATED APPLICATIONS

None.

### FIELD OF THE INVENTION

The invention relates generally to work vehicle window assemblies. More particularly, it relates to such an arrangement wherein windows of a work vehicle can be latched in multiple positions. More particularly, it relates to a support bonding method that prevents undesired breakage of the window panel.

### BACKGROUND OF THE INVENTION

Backhoes, excavators, tractors and other work vehicles must be operated in widely varying environmental and terrain conditions. The operator typically sits in an enclosed operator compartment surrounded by windows. The operator seat may revolve allowing work to occur when facing in multiple directions, therefore the sides of the operator compartment must be designed for maximum visibility. At the same time, there must be a means of operator ingress and egress and adequate ventilation. A significant portion of the compartment's walls are therefore composed of sliding or pivoting windows or doors to accomplish these tasks. The doors and windows require supports and latch mechanisms. These supports and latches must be securely bonded to the windows. The window panels must be further protected from cracking in operation. Often, the windows must open and close independently of the doors, allowing the operator to communicate with outside personnel and achieve comfortable ventilation.

While operating at a work location, the vehicle is subjected to continual vibration. This vibration combined with the weight of the window panel on its supports, cause the window to shift downwards over time. Window panels that are surrounded by a frame do not experience this creep, however the cost of applying a frame to each window is prohibitive. Additionally, window frames obstruct the operator's view. Therefore, window supports and latches are sometimes mounted directly to the window using fasteners that penetrate through the window, such as a bolt and nut combination. Additionally, these penetrating support fasteners need a method of spreading the bonding surface to prevent a high point source of vibration or impact to the window that will result in excessive window cracking. Typically a flexible washer or gasket is used for this purpose, but sometimes window panels are adhesively bonded with a soft material such as double-stick tape. Unfortunately, window panels that are soft bonded in this fashion do not withstand the downward creep caused by the weight of the window panel over time, and allow the panel material to come into contact with the fastener, resulting in panel cracking.

Alternatively, window supports can squeeze the edge of the window panel rather than penetrating the window. In this case additional latches are necessary to secure the window in place on a work vehicle. Window panels in a work vehicle are frequently subjected to high impacts when they are moved between operating positions, i.e. when the operator slams the window open or closed quickly. Slamming the window produces localized stress at the area of contact between the support and the window. The window supports and latches must be able to handle these frequent high impacts without breaking the window panel to which they are attached. The previous support methods of clamping at one edge or penetrating the window will, during a window slam, produce high localized strain levels in the glass. Windows that are supported in an enclosed frame spread the strain levels, but are difficult to remove from the door or wall of the cab, requiring the work vehicle to be driven to a repair facility to replace a broken window. The enclosed frame is also more costly to manufacture and involves several additional parts.

What is needed is a method of attaching a window support to a work vehicle window panel that will resist window creep over time. Additionally, a combined support and latch mechanism is needed which would reduce the number of parts, be simple to manufacture and reliable. Further, the support and latch mechanism must prevent window panel breakage when subjected to high impacts during opening and closing the window. What is further needed is a window assembly that is easily removed from the cab, facilitating window replacement in the field. It is an object of this invention to provide one or more of these benefits in one or more of the embodiments described below.

### SUMMARY OF THE INVENTION

In accordance with a first aspect of the invention, a window support assembly is provided that includes a first plate; a window panel having a first surface and a second surface; and a high modulus of elasticity cured resin first layer bonded to and disposed between the first plate and the first surface of the window panel.

The window support assembly may also include a second plate; and a high modulus of elasticity cured resin second layer bonded to and between the second plate and the second surface of the window panel. The window support assembly may also include a fastener extending through a hole in the window panel, said fastener configured to attach to the first and second plates. The window support assembly may also include a latch handle movably connected to the first plate; and a pin movably connected to the latch handle, said pin configured to engage a window stop. The window support assembly may also include a second plate attached to the second surface; and a fastener configured to couple the first and second plates. The fastener may extend through a hole in the window panel. The fastener may be threaded, and at least one of the first and second plates may be threaded, the fastener being threadably engaged to at least one of the first and second plates. The window support assembly may also include a high modulus of elasticity cured resin second layer bonded to and between the second plate and the second surface of the window panel. The fastener may be an extrusion of one of the inside and outside plates. The first and second plates may be made of metal and the window panel may be made of glass. The latch handle may be a flap.

In accordance with a second aspect of the invention, a window assembly is provided that includes a window panel having first and second edges, the first edge engaging a first channel, and the second edge engaging a second channel, the window panel sliding between the first and second channels, the window panel being supported between the first and second channels; and a first latch bonded with cured resin to the first edge of the window panel.

The window assembly may also include a second latch bonded with cured resin to the second edge of the window panel. The window panel may be supported in a first position in the first and second channels by the first and second latches.

In accordance with a third aspect of the invention, a window assembly kit for a window panel is provided, the window panel having a first side and a second side, and the kit including a resin based uncured adhesive, wherein the adhesive is curable to form a solid; and a first support, the first support abutting a first layer of the adhesive against the first side of the window panel, forming the adhesive into a thin first layer bonded to both the first support and the first side, the first support including a latch configured to engage a window stop.

The window assembly kit may also include a second support abutting a second layer of the adhesive against the second side of the window panel forming the adhesive into a thin second layer bonded to both the second support and the second side.

In accordance with a fourth aspect of the invention, a window assembly for a work vehicle is provided that includes a window having first and second surfaces; and a first rail and a second rail, the first and second rails having at least one stop engagement position; and a first window stop bonded with epoxy adhesive to the first surface, the first stop engaging the first rail at at least one stop engagement position.

The window assembly for a work vehicle may also include a second window stop bonded with epoxy adhesive to the first surface, the second stop engaging the second rail at at least one stop engagement position. The window assembly for a work vehicle may also include a first backing plate bonded with epoxy adhesive to the second surface; and a second backing plate bonded with epoxy adhesive to the second surface. The window assembly for a work vehicle may also include a first support fastener, coupling the first window stop and the first backing plate; and a second support fastener, coupling the second window stop and the second backing plate. The first and second rails may have two or more stop engagement positions.

### BRIEF DESCRIPTION OF THE DRAWINGS

FIG. 1 is a right side view of a work vehicle having a window support assembly in accordance with the present invention.

FIG. 2 is a view of the window assembly taken along line 2-2 of FIG. 1 from the operator's compartment of the work vehicle, showing a top, middle and bottom window panel, the middle window panel being closed (up).

FIG. 3 is a front view of the window assembly of FIG. 2, in which the middle window panel is shown in its alternative position, open (down).

FIG. 4 is perspective view of the middle window panel with two window support assemblies, the window support assemblies being shown in exploded view.

FIG. 5 is a fragmentary view of the window support assembly, taken at section line 5-5 of FIG. 4, the window support assembly being shown in exploded view.

FIG. 6 is a fragmentary cross section view of the window support assembly, the window support assembly being shown fully assembled.

FIG. 7 is a fragmentary perspective view of the middle window panel in a stop position, showing the window support assembly, the top window, the middle window, a window channel, a flap and a stop engagement pin, with the flap up (rest position) and the stop engagement pin extended (engaged).

FIG. 8 is a fragmentary perspective view of the middle window panel of FIG. 7, showing the middle panel in an intermediate position, with the flap depressed (active position) and the stop engagement pin retracted (disengaged).

### DETAILED DESCRIPTION OF THE PREFERRED EMBODIMENTS

In the description below, certain locations are used, such as “top, “middle,” “intermediate” and “bottom,” which indicate relative positions in a vertical direction. An object is in a “top” position if it is in the highest possible working position relative to the ground, and at the “bottom” position if it is in the lowest possible working position relative to the ground. The terms “middle” and “intermediate” refer to one or more working positions between the “bottom” and the “top” positions.

A “flap” shall mean a member that can be manipulated both to release the window and to position the window in its channels, without changing the grasp of the hand.

We refer now to the FIGURES, in which FIG. 1 shows work vehicle 100 which includes an operator cab 102. The cab is composed of structural frame members 104, a roof 106, fixed window panels 108, movable window panels 110, and a door 112. The work vehicle will typically have work implements 114 mounted on the front or rear of the vehicle. During normal operation, the operator sits in the cab and looks through the windows to view the work implements and the terrain. Thus it is necessary to maximize the viewing capabilities in all four directions (front, rear, left and right), and large windows are preferred. The operator will also need ventilation and the ability to open one or more windows while the vehicle is in operation.

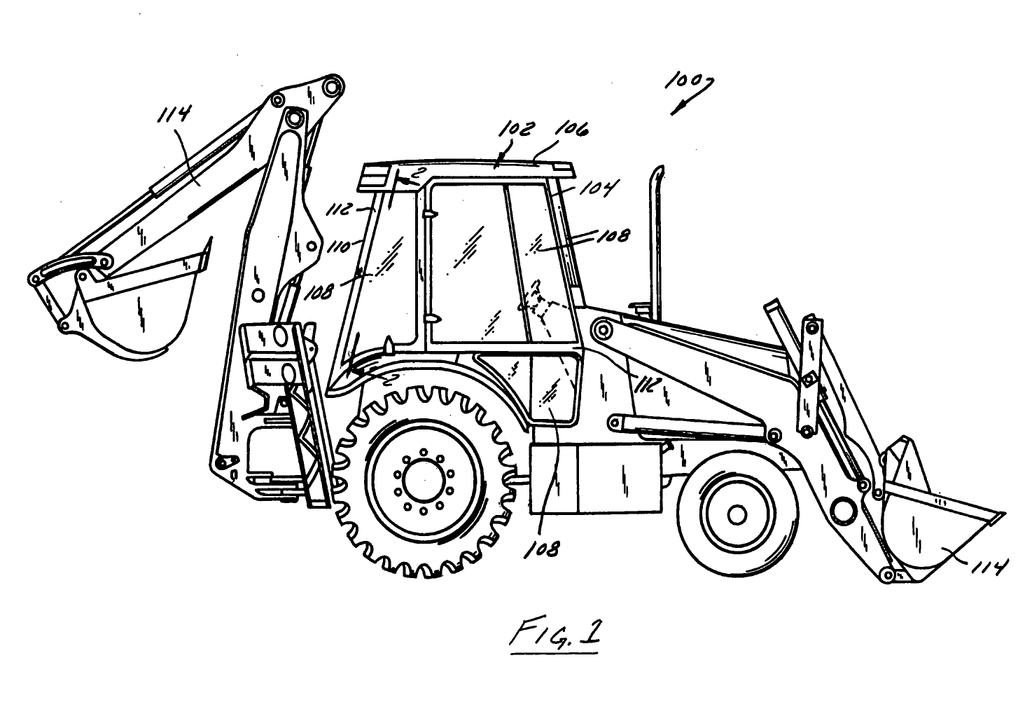

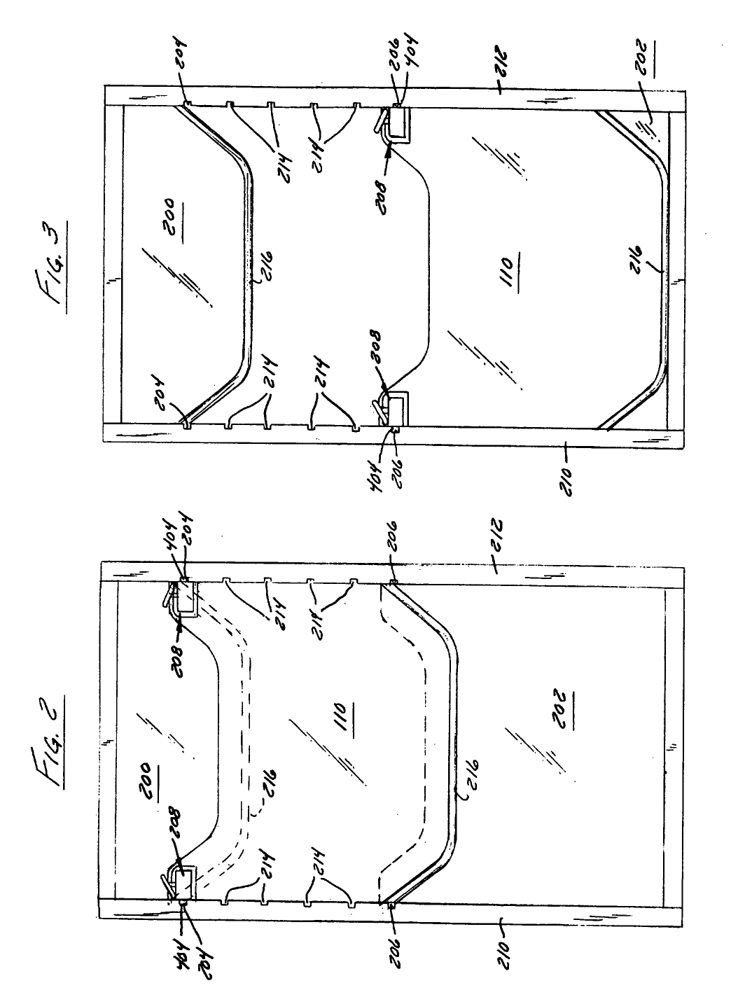

FIGS. 2 and 3 show a rear window assembly of a work vehicle composed of three window panels, supporting channels, and window support assemblies. The top window panel 200 and bottom window panel 202 are mounted above and below the middle window panel 110, which moves vertically between the top stop position 204 and the bottom stop position 206. The window support assemblies 208 engage in the stop positions to both support the window and fix it into a working position. There is considerable vibration while the vehicle is in operation, so the window is preferably guided in channels, here are shown the left channel 210 and right channel 212. While the channels help to restrict the movement of the window horizontally, they provide no support. The combined weight of the window and support assemblies is supported by the window support assemblies 208. The support assemblies 208 preferably are located on the inside surface of the window, to allow the operator to change the window position while remaining in the cab.

If no ventilation is required, the operator will move the window to the top position, restricting airflow in and out of the operator compartment. If maximum ventilation is required, the operator will likewise slide the window vertically downward to the bottom position. However, there are preferably one or more intermediate window stop positions 214 to allow the operator to vary the amount of air flow in gradual steps between no flow and maximum flow. To further restrict air flow between the windows, weather-strips 216 are preferably used along the edges of the window panels to seal each window panel against the adjacent window panel.

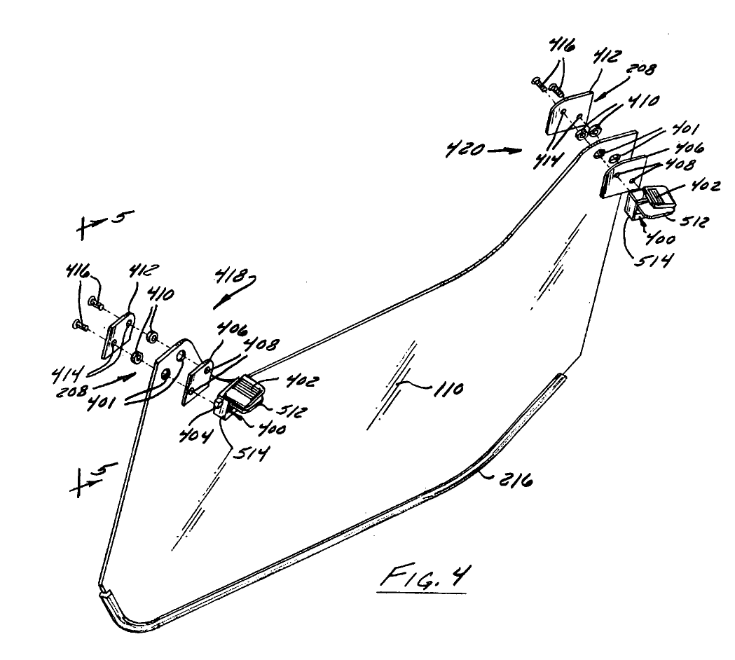

FIG. 4 shows a typical movable window panel 110 with one or more apertures therethrough 401, without the channels, including a left window support assembly 418 and a right window support assembly 420. Left side window support assembly 418 and right side support assembly 420 are identified as window support assemblies 208. The window support assembly parts are shown in an exploded view and comprise a latch 400 including a flap 402 and a stop engagement pin 404, an inside plate 406 with one or more apertures 408 therethrough, one or more grommets 410, an outside plate 412 with one or more apertures 414 therethrough, and one or more fasteners 416.

The window panel 110 may be of any rigid planar material such as metal or plastic, but is preferably transparent, and more preferably of Plexiglas or safety glass. The weather-strip 216 may be of foam, felt, flocking or any compressible material suitable for indoor/outdoor use. The plates are preferably made of metal, for example aluminum, an aluminum alloy, steel, or a steel alloy.

The left 418 and right 420 window support assemblies 208 are identical in function and mirror images of each other, therefore only one assembly 418 will be described in detail. Only one window support assembly is necessary to bear the weight of the window and allow the operator to open or close the window. However, there are preferably two window support assemblies disposed near the left and right edges of the movable window panel, to allow the operator to adjust the window smoothly.

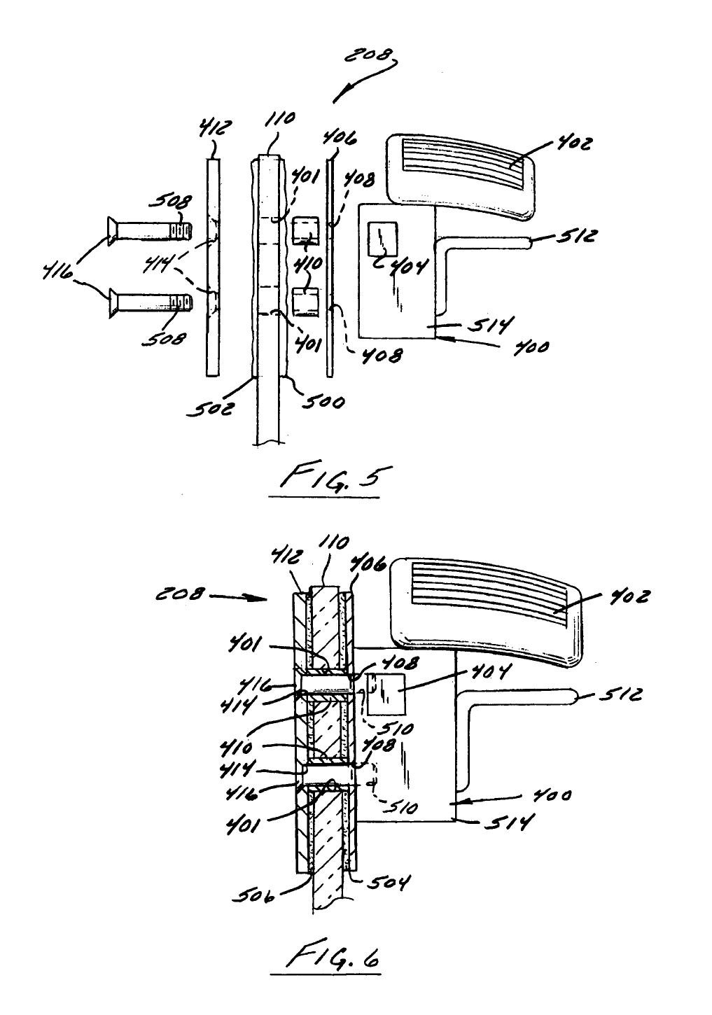

In FIGS. 5 and 6 window support assembly 418 is shown in greater detail. FIG. 5 shows the window support assembly in the process of assembly, while FIG. 6 shows a fully assembled window support assembly. During assembly, an adhesive such as uncured resin is applied to the window panel 110 to form an inside uncured resin layer 500 and an outside uncured resin layer 502.

The preferred adhesive for this application is a high modulus of elasticity, high-strength, high-hardness epoxy resin-based adhesive, curable at ambient temperature, and typically a 2-part system comprised of an epoxy resin with a curing agent. A good example is a catalyzed epoxy resin-based adhesive by Permabond, a division of the National Starch and Chemical Company (Bridgewater, N.J.), that is identified as “Flexon F246.” Other products having a similar strength, elasticity and hardness would also be well suited for this application, such as a variety of structural acrylics. Materials having a shear strength in the range of 2000-15000 psi are preferred as adhesives. More particularly, materials having a shear strength in the range 3500-10,000 psi are preferred. Even more particularly, materials having a sheer strength in the range of 4000-8000 psi are preferred.

Epoxy acrylate oligomers are preferred adhesives. They are characterized by hardness, fast cure, abrasion resistance and resistance to chemicals and weather. The epoxies may be liquid or solid, however liquid epoxy resins are preferred, and typical epoxy resins appropriate for adhesive applications include Bisphenol-A and Bisphenol-F epoxy resins and their derivatives. Curing agents include Aliphatic and Polyamine hardeners. Using a curing agent at ambient temperature is a preferred method. Alternative curing methods include application of heat (thermo set), application of infrared radiation, induction, exposure to ultraviolet radiation (UV), and exposure to electron beam (EB). Resin types are many, dependent on curing method chosen and adhesion properties. When cured, the resin and curing agent form a hard adhesive bond because they are tied together at a molecular level to form a crosslinked network. These embodiments preferably use a high modulus of elasticity 2-part epoxy curable at ambient temperature, however 1-part epoxies and alternate curing methods may be used.

Resin application may be achieved by various methods, including spreading with a brush or knife, or applying directly from a tube. The adhesive could also be applied to the inside plate 406 and the outside plate 412 in place of or in addition to the layers 500,502 on window panel 110. The inside plate 406 and outside plate 412 are clamped to the window panel 110 thus removing air bubbles and forming a thin layer of resin between each plate and the window panel. Excess resin is removed with a rag or spatula. The resin is cured by one of various means, including ultraviolet light or a specified time duration according to the resin manufacturer. When the adhesive has cured to a hard bond, the clamp is removed. The inside plate 406 is now bonded to the window panel 110 with an inside cured resin layer 504. The outside plate 412 is similarly bonded to the window panel 110 with an outside cured resin layer 506.

By laminating an inside and outside plate to the window glass with a layer of high elastic modulus epoxy, breakage is reduced or eliminated. The adhesive resin serves two purposes: 1) it reduces the high localized stresses in the glass by distributing the stresses over a larger surface area, and 2) the adhesive acts as a buffer between the glass and the plate so that the plate does not contact the glass.

During the bonding process the inside plate apertures 408 are aligned axially with the window panel apertures 401. Likewise, the outside plate apertures 414 are aligned axially with the window panel apertures 401.

The preferred embodiment uses two fasteners 416 and two grommets 410. The grommets are used as fixturing and isolating devices, preventing the fasteners from touching the window panel 110. The grommets are preferably made of a softer material such as plastic or rubber to prevent window breakage. The grommets 410 are inserted into the window panel apertures 401. The fasteners 416 are inserted from the outside through the outside plate 412, the outside resin layer 502 or 506, the window panel apertures 401, the inside resin layer 500 or 504, the inside plate 406 and engage the latch body 514 in the latch body apertures 510.

The fasteners 416 may be inserted before or after the resin curing process. If the fasteners are inserted through the uncured resin layers 502 and 500, spreading them into thin layers, the fasteners also serve as clamps during the adhesive curing process. Otherwise clamps are used during the curing process and the fasteners are inserted through the cured resin layers 506 and 504.

The grommets 410 isolate the fasteners 416 from the window panel 110, and the hard cured resin layers 504,506 prevent the glass/plate bond from shifting. The plates 406,412 have apertures 408,414 with preferably a smaller diameter than the window panel apertures 401. This restrains the fasteners from having direct contact with the glass. Thus neither the fasteners 416 nor the plates 406,412 will directly touch the glass regardless of vibration or slamming of the window.

FIG. 5 shows two fasteners 416 with threaded ends 508. These ends engage in similarly threaded latch apertures 510 in the latch 400. The preferred embodiment uses threaded fasteners, however the inside plate or outside plate may also have an extruded fastener that penetrates the window panel and engages the opposite plate. The FIGURE also shows separate grommets 410, however these may be extrusions of either the inside or outside plate if desired.

FIG. 5 also shows relative location of the latch 400 elements, specifically flaps 402 and 512. The operator grasps flaps 402 and 512 simultaneously with one hand, and squeezes them together. Flap 402 moves while flap 512 remains stationary. Flap 402 is coupled to the stop engagement pin 404 such that the movement of flap 402 causes the engagement pin to retract and extend. When flap 402 moves toward flap 512 the stop engagement pin 404 is retracted.

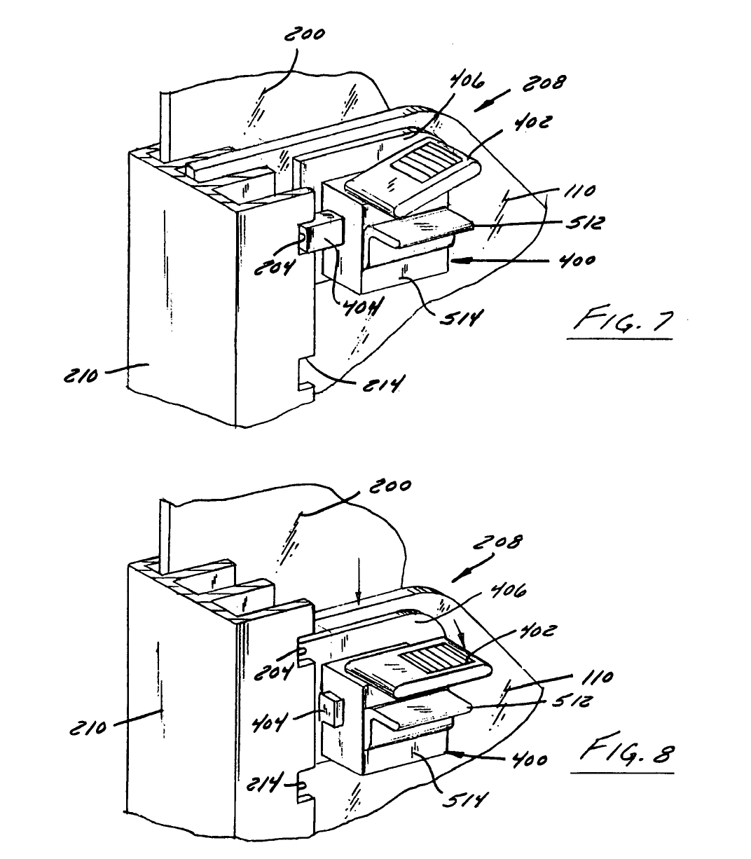

FIGS. 7 and 8 show the operation of the latch 400. In FIG. 7 the latch is engaged. Flap 402 is not pivoted toward the fixed flap 512, and the stop engagement pin 404 is in its extended locking position. In this example, the window panel 110 is locked at the top stop position 204. FIG. 8 shows the state of the latch 400 when the window panel 110 is being moved to a new position. Flap 402 is pivoted toward the fixed flap 512. Flap 402 is coupled to the stop engagement pin 404 such that the stop engagement pin is in its retracted movement position while the window is being moved between the top stop position 204 and an intermediate stop position 214.

FIGS. 4, 5 and 6 show multiple fasteners for each window support assembly, which is the preferable embodiment. However, a single fastener will also provide sufficient clamping strength, therefore in an alternative embodiment there may be only one fastener. The FIGURES also show the preferred embodiment of an inside and outside plate. However, a single plate with a cured resin bond to the window panel may be used to provide sufficient bonding surface area to eliminate window cracking in place of the dual plates. The FIGURES show fasteners which penetrate the window panel, requiring apertures to be drilled through the window panel. This may be prohibitively expensive and otherwise decrease the structural integrity of the window panel, therefore non-penetrating fasteners may be used instead, such as a fastener that wraps around the edge of the panel. The FIGURES also show a flap mechanism for activating the stop engagement pin, which is the preferred method, however a knob, pushbutton or other device may be substituted for or added to the illustrated mechanism to provide comparable engagement and disengagement activation. The adhesive may be a single part epoxy or a solid rather than liquid. The plates may be high tensile strength composite or plastic. The adhesive may be an acrylic plastic, acrylate, a cyanoacrylate or a methyl methacrylate based adhesive. All are high modulus of elasticity products.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

1. A window support assembly comprising:
a first plate;
a window panel having a first surface and a second surface; and
a high modulus of elasticity cured resin first layer bonded to and disposed between the first plate and the first surface of the window panel.

2. The window support assembly of claim 1, further comprising:
a second plate; and
a high modulus of elasticity cured resin second layer bonded to and between the second plate and the second surface of the window panel.

3. The window support assembly of claim 2, further comprising:
a fastener extending through a hole in the window panel, said fastener configured to attach to the first and second plates.

4. The window support assembly of claim 1, further comprising:
a latch handle movably connected to the first plate; and
a pin movably connected to the latch handle, said pin configured to engage a window stop.

5. The window support assembly of claim 4, further comprising:
a second plate attached to the second surface; and
a fastener configured to couple the first and second plates.

6. The window support assembly of claim 5, wherein the fastener extends through a hole in the window panel.

7. The window support assembly of claim 6, wherein the fastener is threaded, and at least one of the first and second plates is threaded, said fastener being threadably engaged to said at least one of the first and second plates.

8. The window support assembly of claim 7, further comprising:
a high modulus of elasticity cured resin second layer bonded to and between the second plate and the second surface of the window panel.

9. The window support assembly of claim 8, wherein the fastener is an extrusion of one of the inside and outside plates.

10. The window support assembly of claim 9, wherein the first and second plates are made of metal and the window panel is made of glass.

11. The window support assembly of claim 10, wherein the latch handle is a flap.

12. A window assembly comprising:
a window panel having first and second edges, said first edge configurably designed to engage with a first channel, and said second edge configurably designed to engage with a second channel, said window being configured to slide between said first and said second channels, said window being supported between said first and said second channels; and
a first latch bonded with cured resin to said first edge of said window panel.

13. The window assembly of claim 12, further comprising:
a second latch bonded with cured resin to said second edge of said window panel.

14. The window assembly of claim 13, wherein said window is configured to be supported in a first position in said first and said second channels by said first and second latches.

15. A window assembly kit for a window panel, said window panel having a first side and a second side, said kit comprising:
a resin based uncured adhesive, wherein the adhesive is curable to form a solid; and
a first support, said first support configured to abut a first layer of said adhesive against said first side of said window panel and to form said adhesive into a thin first layer bonded to both the first support and the first side, wherein said first support includes a latch configured to engage a window stop.

16. The window assembly kit of claim 15, further comprising:
a second support, said second support configured to abut a second layer of said adhesive against said second side of said window panel and to form said adhesive into a thin second layer bonded to both the second support and the second side.

17. A window assembly for a work vehicle comprising;
a window having first and second surfaces; and
a first rail and a second rail, said first and second rails having at least one stop engagement position; and
a first window stop bonded with epoxy adhesive to the first surface, said first stop configured to engage said first rail at said at least one stop engagement position.

18. The window assembly for a work vehicle of claim 17, further comprising:
a second window stop bonded with epoxy adhesive to the first surface, said second stop configured to engage said second rail at said at least one stop engagement position.

19. The window assembly for a work vehicle of claim 18, further comprising:
a first backing plate bonded with epoxy adhesive to the second surface; and
a second backing plate bonded with epoxy adhesive to the second surface.

20. The window assembly for a work vehicle of claim 19, further comprising:
a first support fastener, configured to couple the first window stop and the first backing plate; and
a second support fastener, configured to couple the second window stop and the second backing plate.

21. The window assembly for a work vehicle of claim 20, wherein each of said first and second rails has at least two stop engagement positions.
